(19) United States
(12) Patent Application Publication
(10) Pub. No.: US 2026/0275064 A1
(43) Pub. Date: Sep. 17, 2026

(54) METHOD FOR PRODUCING RE-EXPANDABLE POLYCARBONATE BEADS, AND CORRESPONDING POLYCARBONATE BEADS

(71) Applicant: Covestro Deutschland AG, Leverkusen (DE)

(72) Inventors: Marius Nolte, Köln (DE); Andreas Klein, Leverkusen (DE); Anna Bronova, Bonn (DE); Birgit Mannel, Mülheim an der Ruhr (DE); Daniel Raps, Köln (DE); Dirk Dijkstra, Leverkusen (DE); Volker Altstädt, Hamburg (DE); Nick Weingart, Bayreuth (DE)

(21) Appl. No.: 19/473,525

(22) PCT Filed: Apr. 18, 2024
(86) PCT No.: PCT/EP2024/060484

§ 371 Date: Oct. 8, 2025

(30) Foreign Application Priority Data
Apr. 19, 2023 (EP) 23168654.4

(51) Int. Cl. C08J 9/18; C08J 9/232

(52) U.S. Cl. CPC C08J 9/18; C08J 9/232; C08J 2205/05; C08J 2369/00

(57) ABSTRACT

The invention relates to a method for producing re-expandable foamed polycarbonate beads as well as to the corresponding beads themselves which can be used as propellant-free beads for producing molded parts, even molded parts with complex 3D geometries, in the form of drop-in technology in steam molding machines already used for EPP production at average pressures of 4 to 6 bar and which lead to molded parts with an excellent compact and closed surface structure.

The invention relates to post-expandable polycarbonate beads (a particle foam), to a production process for these polycarbonate beads, and to molded articles obtainable from the polycarbonate beads and a corresponding production process.

Particle foams, and here in particular EPS, EPP and E-TPU, are becoming increasingly important. Modern technology now makes it possible to produce particle foams of reliable quality and to use these particle foams to produce components having advantageous properties. The lower bulk density compared to the “simple” thermoplastics opens up new fields of application for the expanded materials, or conventional applications can be achieved with distinct weight savings. Expanded thermoplastics are thus an attractive material, especially for lightweight applications, provided that application-specific properties are sufficiently good. Mold developments in recent years permit production even of components having surfaces having such an appearance that even visible parts made of expanded thermoplastics are a real alternative to corresponding injection moldings, while having distinctly lower weight. Because of the lower material consumption, the expanded materials are also attractive from a sustainability point of view and can additionally contribute to energy savings owing to generally good thermal insulation properties, for instance when they are used as a thermal insulation material or as an additional effect when they are used as an insulation material for noise suppression.

Particle foams made of polycarbonate have also already been described. Particle foams made from engineering thermoplastics are of interest to the automotive industry, for example, owing to properties such as high thermal stability and good fire performance. EPC is a particle foam for-high temperature applications where conventional polymer foams such as EPP fail. DE 4100200 A1 describes a process for producing polycarbonate foam from polycarbonate, in which a transesterification catalyst is added to the aromatic polycarbonate in combination with aromatic polycarbonate acids or water, optionally together with aliphatic hydroxycarboxylic acids and/or aliphatic alcohols. This results in a controlled, partial degradation of the polycarbonate with release of CO₂, which serves to foam the remaining polycarbonate. The polycarbonate foams described in the document have densities around 0.4 to 0.8 g/cm³.

EP 2603549 A1 describes polyester foams and explicitly also considers them to include polycarbonate foams which, as well as a low density, have good processibility. For production of these particle foams, a starting polymer material in which crystallinity, reflected by the enthalpy of fusion, glass transition temperature and melting temperature are in a certain range is chosen. The process for producing the particle foams comprises the providing of corresponding starting polymer components in the molten state, the mixing of a blowing agent component and optionally of one or more additives into the melt, the extrusion and the pelletizing of the blowing agent-containing melt under water under elevated pressure of 1 to 20 bar. EP 2603549 A1 also describes the option in principle of stabilizing the extrusion operation by increasing the molecular weight by adding chain extenders, for example, without giving specific amounts. Nor are there any further requirements placed on the polymer used therein.

EP 3858906 A1 describes a process for producing expandable particles from aromatic polycarbonate by extruding aromatic polycarbonate, pelletizing, impregnating with carbon dioxide as blowing agent and expanding the particles, followed by shaping of the particles to obtain an expanded molding.

The processing of particle foams, including polycarbonate beads, to molded articles can be effected via several processes, e.g. by variothermal means (thermally by heating) or by the established steam process, here preferably by the steam process. In the steam process, the particle surface is partly melted or softened in the water vapor molding machine using water vapor under pressure, i.e. with attainment of high temperatures in the steam by high pressure, which leads to interdiffusion of polymer chains between different beads and the resulting cohesion of the beads. For a high welding quality between the polycarbonate beads, steam pressures of 7 to 11 bar (165.0-184.1° C.), more preferably 8 to 10 bar (170.4-179.9° C.), have been required to date for EPC. Good cohesion between the particles and a low proportion of macropores/interstices, i.e. cavities between particles in the component owing to poor packing, are necessary for favorable mechanical properties of the resulting molded articles. Homogeneous production of molded articles is ensured by overfilling the mold and is limited to simple geometries. Shaping of complex 3D components from polycarbonate beads is thus not yet possible.

The molding machines already used in practice for EPP (expanded polypropylene) or EPS (expanded polystyrene) can be divided into three working ranges: “low-pressure” up to 2 bar, “mid-pressure” 3-10 bar and “high-pressure” 11-20 bar. The “low-pressure” molding machines achieve a temperature of 120° C. at a maximum vapor pressure of 2 bar and are only suitable for welding of EPS. In the case of water vapor molding machines, there is firstly a correlation of energy expenditure and hence operating costs with the working pressure range, and it is secondly the steam pressure that determines the temperature of the steam and hence the processibility of the polymer, and so the welding service providers and their molding machines are specialized for the processing of EPP in the pressure range of 3-6 bar, usually 3-4 bar.

The object was thus also to provide polycarbonate beads that can be processed by means of steam at moderate steam pressures in the range of 4-6 bar to form molded articles of good quality, in particular also to form such molded articles with a complex 3D molded article geometry. The vapor pressure in the mold is preferably determined by pressure sensors according to DIN 16086:2006-01.

It has now been found that, surprisingly, molded articles, especially also 3D molded articles, made from “polycarbonate beads” (polycarbonate particle foams) are obtainable at moderate steam pressures of 4 to 6 bar, especially at 4 bar (=absolute pressure of the water vapor), only when an optimal ratio between the molecular weight of the aromatic polycarbonate present in the polycarbonate beads and a branched polymer topology is established via the temperature and dwell time-dependent reaction with a chain extender and the beads are frozen in the entropic non-equilibrium state, which is accomplished by “quenching”, i.e. abrupt cooling. It is suspected that the polymer chains in the beads as obtained by the process of the invention have oriented polymer chains that have been aligned by shear and temperature and are frozen in this state.

When energy is supplied again, here by steam, the polymer chains return to the entropically more favorable state of an entangled polymer with random orientation of the chains.

It is only through reactive particle foam extrusion at high melt temperatures T of T₁=(T_{g}+110° C.) to T₂=(T_{g}+170° C.) with T_{g}=the glass transition temperature of the aromatic polycarbonate, enabled by the chain extender, and presumably through immobilization of the branched polymer topology at the particle surface in a sheared, oriented, entropic non-equilibrium state, that post-expansion can be accomplished. The post-expansion of the particles in the course of welding by means of steam is enabled by relaxation of the entropically unfavorably immobilized branching/crosslinking on the particle surface of the polycarbonate beads without further aftertreatment, in particular also without subsequent gas loading. The person skilled in the art will understand “particle foam extrusion” according to the prior art to mean a complete or partial extrusion process with addition of a blowing gas with subsequent pelletization and cooling to give expanded particles, in the case of amorphous thermoplastics at melt temperatures in the nozzle of T_{g}+10° C. to T_{g}+70° C. with T_{g}=the glass transition temperature of the polymer material. It has been found here that a major role is played both by the content of OH end groups of the aromatic polycarbonate used and the ratio of the OH end groups and the reactive groups of the chain extender, but also by the dwell time of the reactive mixture of aromatic polycarbonate and chain extender in the molten state.

The invention therefore provides a
process for producing post-expandable foamed polycarbonate beads by means of
a) continuous particle foam extrusion of a plastified mixture in an extrusion process, where the mixture contains the following components:
   i) aromatic polycarbonate, where the aromatic polycarbonate, based on the total weight of the aromatic polycarbonate, has a content of OH end groups of at least 350 ppm, determined by 1H NMR spectroscopy with dichloromethane as solvent at room temperature,
   and
   ii) a chain extender suitable for OH groups,
   wherein the aromatic polycarbonate and the chain extender suitable for OH groups are used in such a molar ratio that 0.64-1.10 mol of the reactive group of the chain extender is used per 1 mol of OH end groups of the polycarbonate,
   and
   iii) a physical blowing agent,
   at a temperature T of the plastified mixture of T₁=(T_{g}+110° C.) to T₂=(T_{g}+170° C.), where T_{g} is the glass transition temperature of the aromatic polycarbonate,
   wherein the dwell time of the aromatic polycarbonate and of the chain extender suitable for OH groups in the molten state is at least 4 minutes, and
b) subsequent underwater pelletization of the blowing agent-containing melt at water temperatures T₃=(T_{g}−90° C.) to T₄=(T_{g}−55° C.), where T_{g} is the glass transition temperature of the aromatic polycarbonate, without pressurization or under pressurization of the water up to 3.5 bar.

The final pelletization results in foamed polycarbonate beads which, after opportunity for gas exchange, are free of blowing agents. The final product obtained from the above-described process is thus blowing agent-free, foamed polycarbonate beads. The loss of the remaining blowing agent still present at the moment of pelletization takes place without further intervention even in the course of simple storage of the beads after the process, for which typically less than one hour is sufficient for the beads to be finally blowing agent-free, i.e. there has been a complete exchange of gas. But it is likewise possible to bring the beads to elevated temperature in a controlled manner in order to remove the blowing agent even more quickly. Even storage for several days at a high temperature of 120° C. does not have an adverse effect on later post-expandability in the course of steam diffusion welding.

The content of OH end groups is determined by 1H NMR spectroscopy with dichloromethane as solvent at room temperature by evaluating the ratio of the integrals of the signals at 6.68 ppm (two aromatic protons in ortho positions to phenolic OH groups) and at 1.68 ppm (six methyl protons of the bisphenol A unit).

The glass transition temperature is determined in accordance with DIN EN ISO 11357-1:2017.

“Plastified mixture” means a polymer melt with a homogeneous distribution of its constituents. The polymer melt may, for example, be taken directly from the polymerization reactor as a freshly polymerized material or be guided therefrom directly into a mixing extruder in which chain extender, blowing agent and optionally additives are ultimately conducted at various points. The temperature range given for the plastified mixture means the temperature range in which the melt is present from plastification until it exits from the nozzle. It will be apparent that it is within the scope of the invention if, for example, there is a lower temperature in intake zones of the extruder. It likewise does not deviate from the general concept of the invention if one or more zones at higher temperature are also present somewhere in the extruder, provided that the temperature of the last zones in the particle foam extrusion is within the range given. But it is preferable that particle foam extrusion takes place solely in zones within the specified temperature range.

Unless explicitly stated otherwise, all amounts in ppm in the present invention should be regarded as proportions by weight.

What is meant in accordance with the invention by “to” and “up to” is that the range given includes the respective limit.

There is a minimum value for the amount of the OH end groups and also for the concentration of chain extenders, but also a maximum concentration for foam extrusion at high melt temperatures T in the extruder and at the nozzle (=shaping outlet opening) of T₁=(T_{g}+110° C.) to T₂=(T_{g}+170° C.), preferably T of T₁=(T_{g}+120° C.) to T₂=(T_{g}+160° C.), more preferably in the range from T₁=(T_{g}+130° C.) to T₂=(T_{g}+150° C.) for particle foam production, in order to produce beads for polycarbonate molded articles with good mechanical properties in the density range from 200 to 350 kg/m³, determined by the buoyancy principle according to DIN EN ISO 845:2009-10.

The number of OH groups of the aromatic polycarbonate has a significant influence on whether beads with a low density and good mechanical properties of the resulting molded articles can be obtained. Too many OH groups in the polycarbonate mean excessively high reactivity of the polycarbonate, which ultimately leads to rearrangement reactions of the polycarbonate chain, a decrease in molecular weight owing to excessively fast branching with an associated excessively rapid increase in viscosity (excessively high shear input), and to yellowing. However, too few OH groups in the polycarbonate have the effect that the reaction with the chain extender is inadequate or does not even run. However, this likewise means that no good particle foam with adequate mechanical properties is obtained. Instead, the particle foam then has a large number of broken, collapsed cells.

According to the invention, the OH end group content of the aromatic polycarbonate used in the process of the invention is at least 350 ppm, preferably 350 ppm to 600 ppm, further preferably 380 ppm to 580 ppm, more preferably 400 ppm to 550 ppm, most preferably 450 to 550 ppm, based on the total weight of aromatic polycarbonate used. The reference value here is pure aromatic polycarbonate, not the aromatic polycarbonate-based composition. In order to achieve such an end group content, preferably more than 70% by weight of SPC, based on the total weight of the aromatic polycarbonate used, is used, further preferably at least 80% by weight of SPC, based on the total weight of the aromatic polycarbonate used; most preferably, exclusively SPC is used as the aromatic polycarbonate for the production of polycarbonate beads.

Also important is the concentration of the chain extender. An excessive amount of chain extender leads to non-processibility of the material owing to resultant excessively high viscosities as a result of an excessive increase in molecular weight of the polycarbonate. Too small an amount of chain extender does not result in any significant increase in molecular weight and hence results in an inadequate increase in pressure (viscosity of PC without/with insufficient CE at 300° C. is too low) and ultimately poorer mechanical properties of the final molded articles, in that the reaction of the chain extender with the polycarbonate is a function of time and temperature. The foam extrusion process in the case of bisphenol-A based homopolycarbonate is preferably effected, for example, at a housing temperature of T_{housing} of T_{1housing}=T_{g}+100° C. to T_{2housing}=T_{g}+150° C. and a melting temperature T of about T_{g}+(110 to 170° C.) after the blowing agent has been mixed in and dissolved. Particle foam production without cooling results in collapsed particles of high density. Depending on the process control, the stabilization and solidification of the foam structure via cooling means that foam expansion is stopped too quickly. The high temperatures in the process make it possible to exploit the full foaming potential of the formulation under cooling by compensating for the excessively fast cooling/solidification. However, with these temperature profiles, the pressure on the die plate without chain extender is 80-90 bar. The use of chain extenders increases the pressure on the die plate to 140-180 bar, preferably 150-160 bar. Particle foam production is not possible under these process conditions (temperatures) without appropriate chain extension and hence without the additional increase in viscosity.

For the resultant polycarbonate beads to have good properties, it has been found to be essential to the invention that a molar ratio (in a continuous process, there is a throughput-based metered addition) of 1 mol of OH end groups of the polycarbonate to 0.64-1.10 mol, preferably 0.71 to 1.0 mol, further preferably to 0.96 mol, even further preferably 0.8 to 0.9 mol, in particular 0.82 to 0.90 mol, of the reactive group of the chain extender is used.

Preferably, if the content in the aromatic polycarbonate of OH end groups is 400 to 550 ppm, determined by 1H NMR spectroscopy with dichloromethane as solvent at room temperature, 0.71 to 0.96 mol of the reactive group of the chain extender is used per 1 mol of OH end groups of the polycarbonate.

It will be apparent that the provisions according to the claims with regard to the ratio of the molar amounts of OH end groups of the polycarbonate and of the reactive group of the chain extender have to be adjusted in accordance with the process control. In a continuous procedure, there is appropriately a throughput-based adjustment of concentration (mol/h: mol/h ratio).

The use of a chain extender results in an increase in molar mass of the polycarbonate to a range of 40 000 to 230 000 g/mol, preferably 50 000 to 160 000 g/mol, which is associated with an additional increase in pressure on the die plate of about 60 to 100 bar at the temperatures at which polycarbonate is in the plastified state. Suitable chain extenders are in principle amines, carboxyl compounds, maleic anhydride-modified compounds, epoxy-functionalized compounds, oxazolines, carbodiimides and/or functionalized polymers, for instance based on acrylate and/or styrene, and having corresponding functional groups. Such compounds may be used alone or in a mixture. Such groups are, for example, amine functions in the amines, carboxyl functions in the carboxy compounds, anhydride functions in maleic anhydride-modified compounds, epoxy functions in epoxy-functionalized compounds or other functions that can react with the OH end groups of the polycarbonate so as to increase chain length. Preferred chain extenders are in particular epoxy-functionalized compounds, most preferably epoxy-functionalized styrene-acrylic-based polymers, which are supplied by BASF SE, for example, as Joncryl additives, e.g. Joncryl ADR 4368, ADR 4400, ADR 4468. The amount/weight of chain extenders has to be matched to the aromatic polycarbonate, such that 0.64 to 1.10 mol, preferably 0.71 to 1.0 mol, further preferably to 0.96 mol, even further preferably 0.8 to 0.9 mol, in particular 0.82 to 0.90 mol, of the reactive group of the chain extender is used per 1 mol of OH end groups of the polycarbonate. Proceeding, for example, from an aromatic polycarbonate having 350-600 ppm of OH end groups, reacted with a chain extender having an epoxy equivalent weight of 310 g/mol, for example with Joncryl ADR 4468, in concentrations of 0.4-1.2% by weight, preferably 0.5-1.0% by weight, more preferably in concentrations of 0.7-0.9% by weight, where the amount of chain extenders is based on the resulting overall composition (aromatic polycarbonate-based composition, i.e. including any blend partners and any additives, plus chain extenders), the ranges of the reactive group ratios can be attained. By controlled adjustment of the molar ratio of 1 mol: 0.64 to 1.10 mol, molecular weight ranges of 50 000 to 160 000 g/mol, preferably to 155 000 g/mol, determined as described, are attained.

The process of the invention can be a one-stage, a two-stage or else a more than two-stage extrusion process. The reaction to increase the molecular weight can be implemented with a sufficient dwell time through multiple extrusion steps. The dwell time in the case of several steps encompasses the cumulative timespan, i.e. the entire timespan of the polymer-chain extender mixture in the molten state in which a molecular weight-increasing reaction can take place, until discharge.

If the process is a two-stage process, the molecular weight of the polymer is increased in the first extrusion step in the presence of the chain extender, giving a pelletized polycarbonate as the first product. In the second extrusion step, foaming is effected with the physical blowing agent, preferably carbon dioxide, with the ultimate result of the subsequent underwater pelletization being the polycarbonate beads of the invention.

According to the invention, a minimum dwell time of 4 minutes is envisaged. Depending on the system setup, an upper limit arises from the maximum processible viscosity. The molecular weight-increasing reaction, which is a function of temperature and time, has a maximum. Theoretically, the mixture can be reacted to completion. The viscosity is thus correspondingly high. At this point, it may be the case that systems stop because of an excessively high viscosity or else continue to operate and hence mechanically destroy the polymer chains again. A dwell time of up to 15 min, preferably up to 420 s, is typically manageable without difficulty.

The melt is extruded at the exit opening of the extruder through a nozzle plate after blowing agent has been mixed in and dissolved, generally at a temperature of the melt T of T₁=(T_{g}+110° C.) to T₂=(T_{g}+170° C.), preferably of T₁=(T_{g}+120° C.) to T₂=(T_{g}+160° C.), more preferably in the range of T₁=(T_{g}+130° C.) to T₂=(T_{g}+150° C.). The temperature of the nozzle plate is additionally preferably set to a temperature of T_{g}+(130 to 150° C.) in order to prevent freezing of the nozzle by cooling polymer melt and hence to ensure the constant polymer pelletization, and to achieve corresponding foam expansion with maximum potential for expansion.

The diameter of the nozzle opening for a single-hole nozzle is preferably in the range from 0.8 to 3 mm, preferably 1.0 to 2.4 mm. For multi-hole nozzles, nozzle diameters from 0.4 to 0.8 mm are preferred, more preferably of 0.6 mm.

Pelletizing is effected by means of a die plate at an exit opening of the extruder in that the material is extruded and then cut to length. Cutting-to-length is accomplished by means of a cutting device which is typically directly downstream of the forming tool through which the material is extruded.

The pelletizing of the melt to conclude the process of the invention is effected by underwater pelletization at a pressure in the water circuit, which, in the process of the invention, is 0 to 3.5 bar, preferably 1 to 2 bar, i.e. the underwater pelletization is undertaken without additional pressurization of the water or with pressurization of up to 3.5 bar. As the melt exits from the nozzle, the polycarbonate material undergoes a pressure drop of 140 to 180 bar, preferably of 150-160 bar, but not to the extent of complete depressurization at atmospheric pressure, but rather to the pressure set in the water circuit of up to 3.5 bar. The material foams up, but not as far as would be expected on the basis of the amount of blowing agent available, but is instead quenched in an entropic non-equilibrium state, which causes subsequent post-expansion of the beads. The physical blowing agent, for example carbon dioxide, inflates the polycarbonate material while the gas is diffusing out of the polymer melt. After a certain time, complete or nearly complete exchange of gas has taken place, such that only the normal air composition can be found in the expanded polycarbonate which is then in pelletized form, the polycarbonate beads. The polycarbonate beads are thus “blowing agent-free”.

For performance of reactive particle foam extrusion, the following setup arrangements with a sufficient dwell time may be used, without limitation thereto:
a) polymerization reactor/(static) extruder/mixer/gas metering system/melt pump/pelletizer
b) extruder (twin/single-screw)/gas metering system/pelletizer
c) extruder (twin/single-screw)/gas metering system/static mixer/pelletizer
d) extruder (twin/single-screw)/gas metering system/heat exchanger/pelletizer
e) extruder (twin/single-screw)/gas metering system/static mixer/heat exchanger/pelletizer
f) twin-screw extruder/gas metering system/single-screw extruder/pelletizer
g) twin-screw extruder/gas metering system/single-screw extruder/melt pump/pelletizer
h) twin-screw extruder/gas metering system/melt pump/heat exchanger/melt pump/pelletizer
i) twin-screw extruder/gas metering system/heat exchanger/melt pump/pelletizer.

The extrusion process can be conducted in one or more stages.

In detail, the process can be implemented in various arrangements. Important steps in the process are: melting of the aromatic polycarbonate-based composition, optionally addition of nucleating agents (talc, in particular nanoscale talc, graphite, carbon black, pigments etc.), dosage of the blowing agent via liquid dosing systems (for example from Lewa GmbH in Germany) or compression units (high-pressure units) (for example from Maximator GmbH in Germany), optionally pressure buildup up to the die plate via cooling, for example, suitable die plate geometry, addition of reactive macromonomers or via technical aids such as breaker plates or melt pumps (the pressure is preferably increased by adding reactive macromonomers or via utilization of technical aids), and lastly the chopping of the pellets/bead via pelletization in liquid medium, hot chopping or under-gas pelletization, where it is also possible to use gas mixtures. It should be noted that the liquid medium used here may not only be the medium of water, but also an alternative medium such as glycerin or glycerol.

Particularly preferred for performance of the process of the invention is a setup consisting of a twin screw, a gas metering system, a melt pump, a heat exchanger, a second melt pump and an underwater pelletization. In this case, the twin-screw is further preferably used for plastification of the aromatic polycarbonate-based composition and for mixing the physical blowing agent and the chain extender, and the heat exchanger for the dwell time and molecular weight-increasing reaction.

The metered addition of the physical blowing agent to the melt containing the aromatic polycarbonate and the chain extender that reacts throughout the process is more preferably effected in the last third of the first extrusion unit (depending on the construction). The mixing is preferably effected in such a way that the polymer melt ultimately contains the blowing agent dissolved in homogeneous distribution, where the proportion of the physical blowing agent in the mixture for CO₂ is preferably 1.0% to 2.3% by weight, further preferably 1.2% to 1.7% by weight, more preferably 1.3-1.5% by weight, and for N₂ preferably 0.1% to 0.5% by weight, further preferably 0.1% to 0.3% by weight, more preferably 0.15% to 0.25% by weight and most preferably 0.15% to 0.2% by weight, based on the total weight of polymer melt (=polycarbonate-based composition) with chain extender.

For initiation of foam cell formation for a finer and more homogeneous cell morphology, nucleating agents such as talc, in particular nanoscale talc, graphite, carbon black, pigments etc. are added in low concentrations of 0.1% to 1.0% by weight, further preferably 0.15% to 0.5% by weight, more preferably in concentrations of 0.2% to 0.3% by weight, where the amounts are based on the resulting overall composition of polycarbonate-based composition and chain extender.

In principle, physical blowing agents used may be any of the blowing agents commonly used for the foaming of thermoplastics. Examples here are propane, butane, n-pentane, isopentane, but also similar aliphatic hydrocarbons, including aromatic hydrocarbons, alicyclic hydrocarbons, aliphatic alcohols, carbon dioxide, nitrogen, compressed air, inert gases such as argon or helium, and others. “Air” under atmospheric pressure is not considered to be a blowing agent for the purposes of the present invention. According to the invention, “compressed air” means air having a higher pressure than atmospheric pressure. Combinations of two or more of these blowing agents can also be used as physical blowing agent. Preference is given to using carbon dioxide, one or more inert gases, nitrogen, air or mixtures thereof as physical blowing agents, since these are not only of no toxicological and environmental concern, but also do not promote fire. Very particular preference is given to nitrogen, carbon dioxide or a mixture of these, and the greatest preference to carbon dioxide.

If nitrogen is used as physical blowing agent, preferably 0.1% to 0.5% by weight, further preferably 0.1% to 0.3% by weight, more preferably 0.15% to 0.25% by weight and most preferably 0.15% to 0.2% by weight of nitrogen is used, based on the polymer melt including chain extenders and additives (i.e. polycarbonate-based composition plus chain extenders).

If carbon dioxide is used as physical blowing agent, preferably 1.0% to 2.3% by weight, more preferably 1.2% to 1.7% by weight, more preferably 1.3% to 1.5% by weight of carbon dioxide is used, based on the polymer melt including chain extenders and additives.

By the process of the invention, post-expandable polycarbonate beads can be obtained, but these are blowing agent-free compared to conventional post-expandable beads. According to the invention, a “bead” means foamed pellets (=particle foam) which typically have a maximum density of not more than 50% of the unfoamed starting material (the aromatic polycarbonate-based composition). The use of particle-foamed polycarbonate, because of the low weight and the impact-resistant properties of the material, combined with higher continuous operating temperatures (stability, for example, in the cathodic electrocoating process) compared to PP, ABS, PE or PA6, makes it possible to significantly reduce the weight of some vehicle components, and also to reduce fuel consumption and CO₂ emissions, while the mechanical properties are maintained even at higher temperatures. In addition, it is to be expected that the availability of foamed polycarbonate will be able to open up a whole range of other fields of application, especially where insulation functions are required at higher temperatures.

The invention also provides post-expandable polycarbonate beads produced by the process of the invention. The invention thus relates to blowing agent-free, foamed polycarbonate beads having a weight-average molecular weight M_{w} of the polycarbonate, determined by GPC measurement in dichloromethane, calibrated against bisphenol A polycarbonate standards, of 50 000 to 160 000 g/mol, characterized in that the blowing agent-free, foamed polycarbonate beads are post-expandable and show post-expansion of 20% to 60% by volume on welding at 4 bar in a water vapor-based process without pretreatment of the beads and where the foamed polycarbonate beads are subject to the following condition:

$$Q = \frac{δ}{{M}_{w}} = 3.2 \cdot {10}^{- 4} to 1.93 \cdot {10}^{- 3} ( ° \cdot \frac{mol}{g} )$$

with
δ=the phase angle in the Van Gurp-Palmen plot, determined at a complex shear modulus |G*|=3000 Pa and a temperature of 240° C., where δ<78.0°, and M_{w} is as described above.

The invention also provides a process for producing molded articles, in particular those with complex 3D geometry, from the polycarbonate beads of the invention, and corresponding molded articles.

The aromatic polycarbonate present in the blowing agent-free foamed polycarbonate beads of the invention has a weight-average molecular weight, determined by GPC in dichloromethane, calibrated against bisphenol A polycarbonate standards, of 50 000 to 160 000 g/mol. The aromatic polycarbonate is the main component of the thermoplastic material of which the polycarbonate beads of the invention, as obtained by the process of the invention, consist.

The starting material for the production of the beads of the invention in the process of the invention is aromatic polycarbonate, preferably in the form of an aromatic polycarbonate-based composition. According to the invention, “in the form of an aromatic polycarbonate-based composition” does not mean that a ready-compounded composition has to be supplied directly to the extruder in which the particle foam extrusion is conducted. This can be done in this way, but it is also possible for the various components of the aromatic polycarbonate-based composition to be fed to the extruder via individual metering elements. “Aromatic polycarbonate-based composition” is simply supposed to mean that the material of which the polycarbonate beads consist may be a composition of any desired sophistication with optional appropriate additization of the polycarbonate.

In the context of the invention, the term “aromatic polycarbonate” is considered to mean both aromatic homopolycarbonates and aromatic copolycarbonates. These polycarbonates may be linear or branched in a known manner.

The polycarbonates present in the compositions are prepared in a known manner from dihydroxyaryl compounds, carbonic acid derivatives, and optionally chain terminators and branching agents.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization process, by reacting dihydroxyaryl compounds with, for example, diphenyl carbonate. Preference is given in accordance with the invention to using polycarbonate that has been prepared by the melt polymerization process, also called “transesterification process”. Polycarbonate used in accordance with the invention has 350 to 600 ppm of OH end groups, this figure relating to the polycarbonate as such, to the polymer itself, without any additives. The amount of OH end groups is based on the total amount of polycarbonate used. It is also possible to use a mixture of polycarbonate that has been obtained by melt polymerization, and one obtained by the interfacial method, provided that the total concentration of the OH end groups in the polycarbonate used is within the specified range. Particular preference is given, however, to using solely polycarbonate that has been prepared by the melt polymerization method.

Dihydroxyaryl compounds suitable for the preparation of the polycarbonates include, for example, hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl) propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl) propane, dimethylbisphenol A, bis(3,5-dimethyl-4-hydroxyphenyl) methane, 2,2-bis(3,5-dimethyl-4-hydroxyphenyl) propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

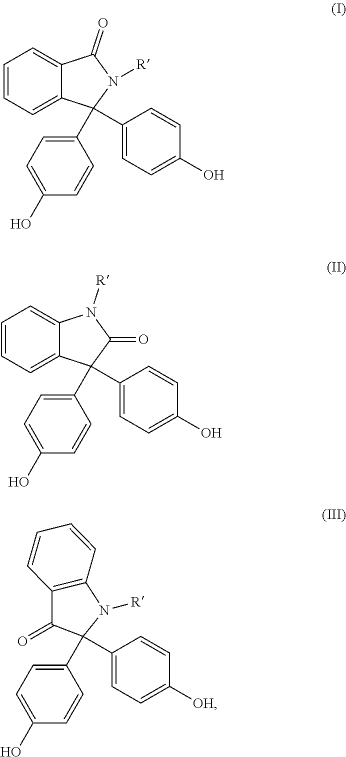

in which R′ in each case represents C₁- to C₄-alkyl, aralkyl or aryl, preferably methyl or phenyl, most preferably methyl.

Particularly preferred bisphenols are 2,2-bis(4-hydroxyphenyl) propane (bisphenol A), 2,2-bis(3,5-dimethyl-4-hydroxyphenyl) propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,635 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964”, and in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives include phosgene or diphenyl carbonate.

Suitable chain terminators that may be used in the production of the polycarbonates include monophenols. Examples of suitable monophenols include phenol itself, alkylphenols such as cresols, p-tert-butylphenol, isooctylphenol, cumylphenol, and mixtures thereof.

Preferred chain terminators are the phenols mono- or polysubstituted by linear or branched C₁- to C₃₀-alkyl radicals, preferably unsubstituted or tert-butyl-substituted. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri (4-hydroxyphenyl)benzene, 1,1,1-tri (4-hydroxyphenyl) ethane, tri (4-hydroxyphenyl)phenylmethane, 2,4-bis(4-hydroxyphenylisopropyl) phenol, 2,6-bis(2-hydroxy-5′-methylbenzyl)-4-methylphenol, 2-(4-hydroxyphenyl)-2-(2,4-dihydroxyphenyl) propane, tetra(4-hydroxyphenyl) methane, tetra(4-(4-hydroxyphenylisopropyl) phenoxy) methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and (III)

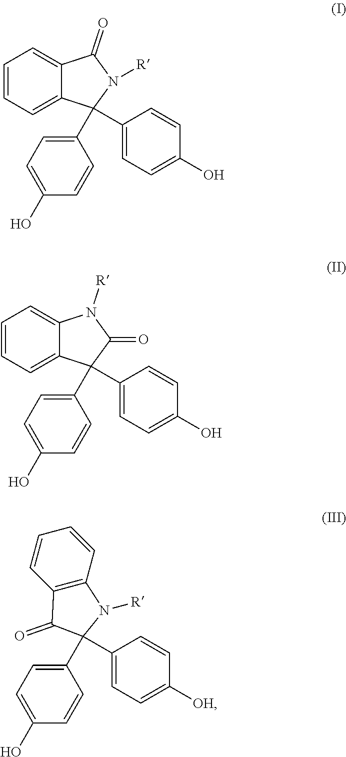

in which each R′ is C₁- to C₄-alkyl, aralkyl or aryl, preferably methyl or phenyl, most preferably methyl,
   especially with bisphenol A. Most preferably, the polycarbonate-based compositions comprise bisphenol A-based polycarbonate; the polycarbonate in the polycarbonate-based compositions is exceptionally preferably bisphenol A-based homopolycarbonate.

Also preferred are copolycarbonates produced using diphenols of general formula (1a):

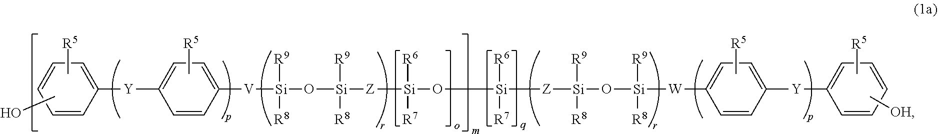

where
R⁵ is hydrogen or C₁- to C₄-alkyl, C₁- to C₃-alkoxy, preferably hydrogen; methoxy or methyl,
R⁶, R⁷, R⁸ and R⁹ are each independently C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or polysubstituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0, W is a single bond, when q=1 and r=0, W is oxygen, C₂- to C₆-alkylene or C₃- to C₆-alkylidene, preferably oxygen or C₃-alkylene,
when q=1 and r=1, W and V are each independently C₂- to C₆-alkylene or C₃- to C₆-alkylidene, preferably C₃-alkylene,
Z is a C₁- to C₆-alkylene, preferably C₂-alkylene,
o is an average number of repeat units from 10 to 500, preferably 10 to 100, and
m is an average number of repeat units from 1 to 10, preferably 1 to 6, further preferably 1.5 to 5. It is likewise possible to use diphenols in which two or more siloxane blocks of general formula (1a) are joined to one another via terephthalic acid and/or isophthalic acid to form ester groups.

Especially preferred are (poly) siloxanes of formulae (2) and (3)

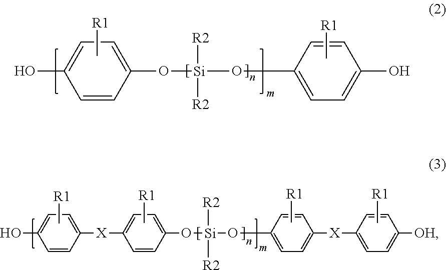

where R1 is hydrogen, C₁ to C₄ alkyl, preferably hydrogen or methyl, and especially preferably hydrogen,
R2 is independently aryl or alkyl, preferably methyl,
X is a single bond, —SO₂—, —CO—, —O—, —S—, C₁ to C₆ alkylene, C₂ to C₅ alkylidene or C₆ to C₁₂ arylene, which may optionally be fused with further aromatic rings containing heteroatoms,
X is preferably a single bond, C₁ to C₅ alkylene, C₂ to C₅ alkylidene, C₅ to C₁₂ cycloalkylidene, —O—, —SO—, —CO—, —S—, —SO₂—, more preferably X is a single bond, isopropylidene, C₅ to C₁₂ cycloalkylidene or oxygen, and very more preferably is isopropylidene,
n is an average number from 10 to 400, preferably 10 to 100, especially preferably 15 to 50, and
m is an average number from 1 to 10, preferably from 1 to 6 and especially preferably from 1.5 to 5.

The siloxane block may likewise preferably be derived from the following structure

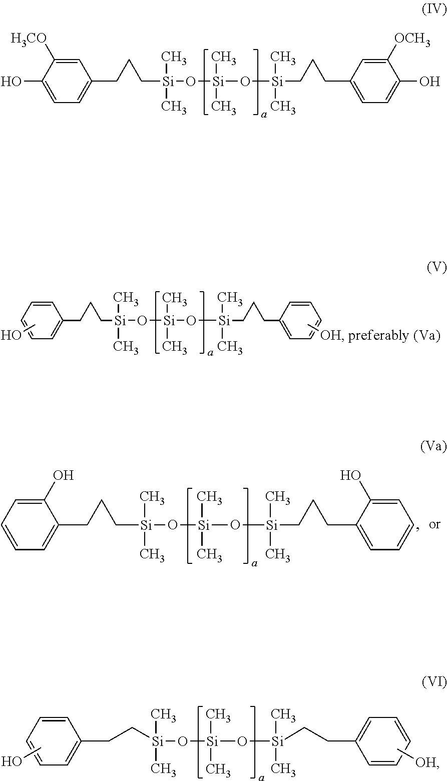

where a in formulae (IV), (V) and (VI) is an average number from 10 to 400, preferably 10 to 100 and more preferably 15 to 50.

It is likewise preferable when at least two identical or different siloxane blocks of general formulae (IV), (V) or (VI) are joined to one another via terephthalic acid and/or isophthalic acid to form ester groups.

It is likewise preferable when, in formula (1a), p=0, V is C₃-alkylene, r=1, Z is C₂-alkylene, R⁸ and R⁹ are methyl, q=1, W is C₃-alkylene, m=1, R⁵ is hydrogen or C₁- to C₄-alkyl, preferably hydrogen or methyl, R⁶ and R⁷ are each independently C₁- to C₄-alkyl, preferably methyl, and o is 10 to 500.

Copolycarbonates having monomer units of formula (1a) and in particular also the preparation thereof are described in WO 2015/052106 A2.

Copolycarbonates having monomer units of formula (IV) and in particular also the preparation thereof are described in WO 2015/052106 A2.

In principle, one or more additives may be added to the aromatic polycarbonate, and indeed directly to the polycarbonate as used as the starting material in the process of the invention. However, one or more additives can also be supplied to the aromatic polycarbonate only during the performance of the process of the invention in the extruder, preferably together with the chain extender. Incorporation via the side extruder is not possible in the process of the invention if only one extrusion stage is used, since the blowing agent is present in the melt and would accordingly escape via the side feed. However, a gas-tight side feed would enable the introduction of the additives in this way. Additives can also be introduced by means of powder premixes or as a masterbatch. Liquid additives can always be injected at any point in the process provided that sufficient homogenization is still possible, preferably in the region of static or dynamic mixing units. Additives can also be added in a first stage and the blowing agent then in a second stage. It is then also possible here to add the additives via a side extruder.

The mixture of aromatic polycarbonate, any blend partners and any additives as starting material is referred to as “aromatic polycarbonate-based composition”. In process step a, “only” aromatic polycarbonate, or else aromatic polycarbonate, is used as aromatic polycarbonate-based composition. If an aromatic polycarbonate-based composition is used, it preferably contains at least 70% by weight, further preferably at least 80% by weight, even further preferably at least 90% by weight, more preferably at least 95% by weight, most preferably at least 98% by weight, of aromatic polycarbonate, based on the total weight of the polycarbonate composition. Exceptionally preferably, the “aromatic polycarbonate-based composition” does not contain any blend partners with the polycarbonate; instead, solely aromatic polycarbonate is used in the process of the invention for producing polycarbonate beads, aside from any additives that are customary for polycarbonate.

Such further additives as customarily added to polycarbonates are in particular heat stabilizers, flame retardants, antioxidants, mold release agents, anti-drip agents, for instance polytetrafluoroethylene (Teflon) or SAN-encapsulated PTFE (e.g. Blendex 449), UV absorbers, IR absorbers, impact modifiers, antistats, optical brighteners, fillers such as talc, quartz, light-scattering agents, transesterification inhibitors, compatibilizers, nucleating agents, colorants, pigments, e.g. titanium dioxide, carbon black, chemical blowing agents and/or additives for laser marking, especially in the amounts customary for polycarbonate-based compositions. Such additives are described for example in EP-A 0 839 623, WO-A 96/15102, EP-A 0 500 496 or in “Plastics Additives Handbook”, Hans Zweifel, 5th Edition 2000, Hanser Verlag, Munich. These additives may be added individually or else in admixture. It will be appreciated that it is only permissible to add such additives, and only in such amounts, if they do not have a significant adverse effect on the production of the beads by the process of the invention.

The additives are preferably selected from the group consisting of heat stabilizers, flame retardants, antioxidants, mold release agents, colorants, pigments, anti-drip agents, UV absorbers, IR absorbers, nucleating agents, impact modifiers, antistats, optical brighteners, light-scattering agents, transesterification inhibitors, compatibilizers and/or additives for laser marking.

The aromatic polycarbonate or the aromatic polycarbonate-based composition preferably has a melt volume flow rate MVR of up to 14 cm³/(10 min), further preferably up to 12 cm³/(10 min), more preferably from 5 cm³/(10 min) to 9 cm³/(10 min), most preferably from 5.5 cm³/(10 min) to 6.5 cm³/(10 min), determined according to ISO 1133:2012-3 (test temperature 300° C., mass 1.2 kg).

The aromatic polycarbonate used in the process of the invention may be a polycarbonate, but also a mixture of two or more aromatic polycarbonates, provided that the content of OH end groups of the entire polycarbonate used is within the inventive range. The OH end group content should be understood in relation to the aromatic polycarbonate, not the aromatic polycarbonate-based composition. It is also possible to use polycarbonate which is a post-consumer or post-industrial recyclate. Appropriate recyclates can be fed to the extruder in the form of pellets or regrind. It is also possible to use recyclate only as a portion of the aromatic polycarbonate.

The foamed polycarbonate beads of the invention are blowing agent-free beads. What is meant by “blowing agent-free” is that only ambient air is present in the foam cells at the time of further processing after exchange of gas. Nevertheless, they show considerable post-expansion, for example in the steam diffusion welding process, since their cell walls and particle surfaces are frozen by underwater pelletization by quenching in the entropic non-equilibrium state.

The polycarbonate beads produced by the process of the invention have a spherical or at least approximately spherical shape. What is meant here by “approximately spherical” is that, if the sphere is described by axes of equal length directed into space from a common origin, the axes defining the radius of the sphere in all spatial directions, there is a variance of the axis lengths from the ideal state of a sphere of up to 20% for the spherical particles.

The post-expanded polycarbonate beads of the invention preferably have an average particle diameter, determined by a Camsizer according to ISO 13322-2, of 1.0 to 3.2 mm, preferably of 2 to 2.6 mm, which can be established by choice of a suitable die plate geometry, i.e. the nozzle size—hole diameter and die land—in the extruder, but also by the throughput, the blade speed and the composition of the blowing agent-containing melt.

The polycarbonate beads have an open-cell content of up to 20%, preferably up to 16%, further preferably up to 15%, even further preferably up to 10%, determined in accordance with DIN EN ISO 4590:2016-12. >80%, preferably >84% of the cells, more preferably >90% of the cells in a bead are intact, i.e. the individual cell structure in these beads is divided by at least three other structural elements (cells) and there are no more than two broken cell walls per single cell. The polycarbonate beads thus have intact (“closed-cell”) or at least predominantly intact cells, and therefore molded foam articles with very uniform, even surfaces and homogeneous welding of the beads can be produced from the polycarbonate beads.

The particle density of the beads before post-expansion, determined in accordance with the buoyancy principle according to ASTM-D-792:2020-07, is 300 to 620 kg/m³.

The phase angle of the polycarbonate beads in the Van Gurp-Palmen plot, determined as described in the examples, at a complex shear modulus |G*|=3000 Pa and a temperature of 240° C., is <78.0°, preferably 64° to <78.0°, further preferably 71° to <75°.

The post-expandable, blowing agent-free, foamed polycarbonate beads are subject to the condition that the quotient of this phase angle in the Van Gurp-Palmen plot and the weight-average molecular weight of the polycarbonate is 3.20·10⁻⁴ to 1.93·10⁻³ (°·mol/g), preferably 4.5·10⁻⁴ to 1.52·10⁻³ (°·mol/g).

For the production of molded articles/components, foam particles can be welded together by variothermal means (thermally by heating) or preferably in a water vapor molding machine. In a water vapor molding machine, the particle surface is partly melted or softened using high-pressure water vapor (i.e. water vapor at high temperature), which leads to interdiffusion of polymer chains between different beads and the resulting cohesion of the beads. Good cohesion between the particles and a low proportion of macropores/interstices, i.e. cavities between particles in the component owing to poor packing, are necessary in order to ensure favorable mechanical properties. The processing of foam beads to the finished part is effected in a molding machine in five steps: 1) complete or partial closing of the mold, 2) filling of the mold, followed by complete closure if necessary, 3) welding of the particles, 4) cooling and stabilization, 5) ejection of the molded article. Two methods are distinguished here: the crack gap method and the pressure filling method. In the pressure filling method, the mold is first closed, then the particles are drawn out of a container by air pressure and blown into the mold by an injector at about 3 bar and compressed therein. The particles expand in the mold and fill the cavities better (corresponding to an overfill of about 10% in the crack gap method). In the crack gap method, the mold is not closed completely, but a certain gap (%) remains open. The mold is then filled with particles, such that the mold is overfilled to a certain percentage (10-20% by volume for EPC to date). The mold is then closed and the particles are compressed to target thickness. If the target thickness of the component is, for example, 20 mm, the mold cavity is opened further for filling, for example 4 mm (=20% by volume), and filled with the polycarbonate beads, and then the mold is contracted to a component thickness of 20 mm. This step is crucial in order to achieve a homogeneous distribution of the beads in the mold. In the third step, the beads are fused together by steam flowing through the mold by a fixed procedure. During steaming, the beads form physical bonds owing to the interdiffusion of polymer chains of adjacent particles. In order to ensure a high quality of welding between the particles, preferably 7 to 11 bar, more preferably 8 to 10 bar, has been employed for EPC to date. In the steam-based welding process in which there is no overfilling, but rather underfilling is possible owing to the post-expansion of the beads, the air between the beads is first flushed out and the mold is preheated. Steam flows in parallel to the mold when the valves are open. In the second step, the steam flows through the mold, which is referred to as cross-steaming. During this step, the mutually opposite steam inlet and outlet valves are open. In order to ensure a very homogeneous temperature distribution and uniform welding quality throughout the part, the mold is preferably steamed from both sides. Finally, with the outlet valves closed, steam is directed into the steam chamber at a particular pressure in order to improve the surface quality by formation of a skin (autoclave steaming). In the fourth step, the molded article is cooled, which is crucial for dimensional accuracy. If the part is ejected without cooling, further expansion of the particles is possible, resulting in a deviation from the original dimensions. For cooling, the mold is sprayed with water until a temperature of about 80° C. has been attained. After forming and cooling, the part is ultimately ejected in the last step, preferably by compressed air and mechanical ejectors.

Molded articles can advantageously be produced from the blowing agent-free, foamed polycarbonate beads of the invention using a standard steam diffusion welding process. What is meant here by “standard” is that this is an established process in machines that are already used to produce molded articles from other polymer foams by a steam diffusion welding process. This is preferably a drop-in technology for the EPP welding process, meaning that the post-expandable polycarbonate beads can be processed in plants to molded articles that are typically used for the production of molded articles from expanded polypropylene, for which the process known from EPP can be utilized. The polycarbonate beads can thus be converted by filling of corresponding cavities to molded articles, even those with complex geometries, ultimately requiring only one corresponding step. There is no need for subsequent cutting-to-size, known from extrusion foams, which is frequently still required, with corresponding formation of waste. Polycarbonate beads are additionally easier to transport than the often bulky sheets of available extrusion foams.

Preference is thus given to the production of molded articles of the invention from post-expandable polycarbonate beads of the invention by means of steam diffusion welding at an average steam pressure of 4 to 6 bar, further preferably at 4.0 to 4.5 bar, in particular at 4 bar.

Because of the spherical or approximately spherical shape of the beads, molded articles with a compact continuous surface can be obtained.

If the polycarbonate beads of the invention do not undergo further pretreatment after they have been produced, but are used as obtained by the process of the invention, the polycarbonate beads in the steam diffusion welding process at 4 bar in water vapor still show post-expansion of 20% to 60% by volume, preferably from 30% to 50% by volume, even though they are blowing agent-free when used in the steam diffusion welding process.

The molded articles of the invention, i.e. sheets, and also those with complex 3D geometry, have a compact continuous surface and in the bending test, determined on the basis of ISO 1209-2:2007, show flexural strain at the force maximum of at least 5.0%, preferably of at least 5.5%, where “on the basis of” here means that the sample thickness was 10 mm, the support width was 100 mm and the outer skin of the samples was removed. The welded sheet cannot be broken manually, regardless of the tester force (dimensions of the sheet in these tests: 300×200×15 mm³).

The component density of corresponding molded articles is preferably 200 to 350 kg/m³, determined in accordance with DIN EN ISO 845:2009-10.

Corresponding molded articles of the invention can be employed in the automotive industry, in transportation, in the construction industry, the aviation industry, the aerospace industry, in the packaging industry, and generally in lightweight construction and/or composite construction. Possible molded articles made of the polycarbonate beads are not only sheets, but also complex, three-dimensional parts.

Molded articles consisting of or comprising the polycarbonate beads of the invention are in particular visible parts in various fields of application, although upgrading with laser textures is also possible, for instance dashboards or interior trim elements, sound insulation elements, infill elements, for example in carpets in a car footwell, a core material or supporting foam part of composite materials, for instance for bodywork insulation for vehicles, especially electric vehicles, in the HVAC field (heating, ventilation, air conditioning) as insulation material, as high-temperature insulation in industry, in housing and building technology or in transportation, barrier and insulation materials, packaging, lightweight construction elements, wind turbine blades, facade components.

### EXAMPLES

### 1. Description of Raw Materials and Test Methods

### a) Raw Materials

PC-1: Aromatic polycarbonate based on bisphenol A, having an MVR of 6 cm³/(10 min) (300° C./1.2 kg, ISO 1133-1:2011) and a softening temperature (VST/B 120; ISO 306:2013) of 149° C. T_{g}, determined in accordance with DIN EN ISO 11357-1:2017: 148° C. M_{w}, determined as described above, about 30 900 g/mol. Contains 0.06% thermal stabilizer and 0.1% UV stabilizer. OH end group content, determined by 1H NMR spectroscopy with dichloromethane as solvent at room temperature: 470 ppm. Produced via the melt condensation (SPC) process.

PC-2: Aromatic polycarbonate based on bisphenol A, having an MVR of 6 cm³/(10 min) (300° C./1.2 kg, ISO 1133-1:2011) and a softening temperature (VST/B 120; ISO 306:2013) of 150° C. T_{g}, determined in accordance with DIN EN ISO 11357-1:2017: 148° C. M_{w}, determined as described above, about 30 900 g/mol at 28 kDA (MALLS). OH end group content, determined by 1H NMR spectroscopy with dichloromethane as solvent at room temperature (as described above): 60 ppm. Produced via the interfacial condensation (LPC) process.

CE-1: A commercially available and multifunctional chain extender from BASF SE (Joncryl ADR 4468) based on styrene/acrylic-based polymer comprising epoxy-reactive groups and having an average molecular weight (gel permeation chromatography in ortho-dichlorobenzene at 150° C. with polystyrene calibration) M_{w}=7250 g/mol, an epoxy equivalent weight of 310 g/mol, determined in accordance with DIN EN 1877-1:2000-12, a glass transition temperature T_{g} of 59° C. and a decomposition temperature of 350° C., determined in accordance with DIN EN ISO 11357-1:2017.

### b) Test Methods

Flexural strain at the force maximum was determined in accordance with ISO 1209-2:2007, “in accordance with” meaning that the sample thickness was 10 mm, the support width was 100 mm and the outer skin of the samples was removed.

Molecular weight was determined by GPC measurement in dichloromethane, calibrated against bisphenol A polycarbonate standards, according to DIN EN ISO 16014-3:2019.

Density of the particles was determined in accordance with the buoyancy principle according to ASTM-D-792:2020-07, and the density of the molded articles according to DIN EN ISO 845:2009-10.

Van Gurp-Palmen plot: values of the phase angles.

The foamed polycarbonate beads were dried in an oven at 110° C. under vacuum for at least 20 h. In order to ensure homogeneous drying, the amount in the drying container was limited such that only the bottom of the container was covered with a layer of beads. The samples thus dried were pressed in a press mask with a diameter of 25 mm in a P/O/Weber PW 20 laboratory press at 200° C. into a transparent test specimen of thickness 1.6 mm without visible gas inclusions. The sample was then cooled to room temperature and transferred immediately to a TA Instruments ARES G2 rheometer preheated to 240° C. After heating for 2 minutes, a low normal force was exerted briefly in order to ensure very good contact between the rheometer tool and the molten sample. The normal force was reduced to 0 as soon as the measurement gap had been reduced to 1.5 mm. The excess material on the edge that had been had been pushed out by the measurement die was removed manually. After temperature control for 120 s, the test specimen of thickness 1.5 mm with a diameter of 25 mm at 240° C. was analyzed under oscillating load at a frequency of 100 Hz up to 0.001 Hz at a deformation of 0.4%. During sample handling and measurement, the rheometer convection furnace was purged with nitrogen gas in order to prevent reaction of the sample with oxygen. After the measurement at 240° C., the temperature in the oven was lowered to 230° C. and the measurement was repeated at an elongation of 0.3%. Then the temperature was lowered to 220° C. and the measurement was repeated at an elongation of 0.2%. In the next step, the temperature was lowered to 210 C and the measurement was repeated at an elongation of 0.12%. Subsequently, the temperature was lowered to 205° C. and the measurement was repeated at an elongation of 0.1%. Then the sample was taken out of the rheometer. Visual inspection of the sample did not show any bubbles.

The results of the rheological measurements at different temperatures, i.e. stored shear modulus G′, loss shear modulus G″ and phase angle δ (=arctan (G″/G′)) were used to create what is called a “Van Gurp-Palmen plot” by plotting the measured phase angle δ against the complex shear modulus |G*|=\sqrt{(G′)²+(G″)²}. This plot was used to determine the phase angle at G*[MPa]=3000 Pa.

Open-cell content was determined in accordance with DIN EN ISO 4590:2016-12.

Cell diameter was determined by SEM (ASTM E1508-12a: 2019).

The size distribution of the beads was determined using a Camsizer.

For the examples, topological images of the molded articles produced (see figures) were also created. The corresponding height profile was created using image-processing software based on photographs of the molded articles. For this purpose, the photograph was converted to a 16-bit grayscale image and a representative area of 2 cm×2 cm was selected. A 3D surface plot of this area with a maximum grit size of 1024 and smoothing of 200 (top view) was created, as was a surface plot (height profile image) as a wireframe with a polygon multiplier of 100%.

### c) Procedure

### Tests to Identify Suitable Material

The tests described hereinafter were conducted using the following setup: twin-screw extruder-gas metering system-single-screw extruder-melt pump-underwater pelletization. Example i) describes a test series with gradual reduction of the OH concentration (ppm) of the polycarbonates with a constant reactive component.
i) A twin-screw extruder (A extruder) from Reifenhäuser (Troisdorf, Germany) with 43 D was run with a throughput of 35 kg/h, at profile temperatures of 100-160° C. (housings 1 to 3), 240° C. (housing 4) to 280° C. (housings 5-10) and a speed of 100 rpm. In addition, chain extender 1 was added in a fixed concentration of 0.7% by weight. In this series, by means of a different proportion of a second polycarbonate, the molar reactive group ratio OH:epoxy was varied between 1:0.82 and 1:1.47 (OH:epoxy, in each case in mol) (tab. 1). The melting temperature was 10-20° C. higher than the housing temperature throughout the system (melting zone of the twin screw up to the die plate). The blowing agent was fed in by means of a Maximator (Maximator GmbH, Germany) and/or by means of a metering station (Lewa GmbH, Germany) at position 6 at a level of 1.3% by weight of CO₂. From position 5, the pressure profiles in the twin screw gradually rose from 45 bar up to the top of the extruder at 270 bar for 100% by weight of SPC. As a result of addition of a PC component low in OH end groups, PC-2, the pressure profiles at first rose slightly to 275 bar at a level of 10%. Further addition of PC component low in OH end groups beyond 20% by weight led to declining pressure profiles. The melt was conveyed via the transfer tube (290° C.) into the single-screw extruder (B extruder) (Reifenhäuser). The B extruder was likewise operated at a continuous housing temperature of 280° C., a throughput of 35 kg/h and a speed of 26 rpm. The melt pump was run under pressure control at a backpressure of 110 bar and a temperature of 280° C. The pressure downstream of the melt pump was determined by the content of the reactive polycarbonate and was reduced by the extrinsic matrix content (shown in detail in tab. 1). The diverter and the die plate were likewise set to a temperature of 280° C. and the melt temperature at the diverter and die plate was T_{g}+140° C. to T_{g}+150° C. The UWP (EUP 50) and the die plate were manufactured by ECON (Econ GmbH, Austria). The die plate consisted of 5 single-hole inserts with a diameter of 2.2 mm and a die land of 3.49 mm. The dwell time of the melt between intake and exit was about 7-10 minutes. Downstream of the exit, the melt was separated off with a rotating 6-blade knife at 1500 rpm and transported away by a cold water circuit at 70-80° C. (28 m³/h). The roundness of the particles gradually decreased, and foam density increased.

In the case of too low a concentration of polycarbonate at OH end groups, specifically <350 ppm, the production process breaks down with a molar reactive group ratio (OH:epoxy, each in mol) of 1:1.12 (outside the scope of the claim). The increase in molecular weight no longer takes place to a sufficient degree, and so the viscosities of the melt mixture and hence the pressures at the die plate are no longer sufficient for a homogeneous particle foam. The resulting particles have a more elongated shape and an inhomogeneity in shape and appearance (as a result of lower viscosity and hence altered flow properties) at higher foam densities (lower pressure drop) (tab. 2). The particles can no longer be welded sufficiently well within the pressure range of 7-11 bar. The components do not have a continuous surface and have many sink points/cavities, which results in poorer thermal conductivity, elevated rigidity, distinctly reduced maximum flexural strain and poorer puncture performance (tab. 2 and tab. 3).

The particles produced were processed by a Teubert TVZ162/100PP molding machine (Teubert Maschinenbau GmbH, Germany) to give components having a density of 200±10 kg/m³ and a geometry of 300× 200×15 mm³. The required pressure for the welding for EPC from the concentration study for the identification of the suitable material was in the range of 7 to 10 bar. Finally, the properties of the components were determined. Scanning electron microscopy measurements (SEM, model: JEOL JSM-6510, Borken, Germany) were performed here with graphite-sputtered samples in order to visualize the morphology. A dynamic-mechanical analysis (DMA) was performed on a Gabo Eplexor 500N from NETZSCH GmbH, (Selb, Germany) in pressure mode on 15×15×15 mm³ samples in the temperature range of −25 to 250° C. at a heating rate of 1 K/min in pressure-regulated mode with an amplitude of 5% (static) and 2% (dynamic) of the sample height at a frequency of 1 Hz. Mechanical characterization was performed using pressure tests, tensile tests and 3-point bending tests (room temperature, 80 and 110° C.) and puncture tests (RT). Pressure tests were conducted in accordance with DIN EN ISO 844:2014-11 up to 60% compression on a Zwick Z020 universal tester from Zwick & Roell (Ulm, Germany) on samples with a geometry of 15×15× 15 mm³ and with a 10 kN load cell. 3-point bending was conducted on the basis of ISO 1209-1:2007-05 with the same universal tester at 10 mm/min and a 20 kN load cell. The samples were skinned in order to eliminate the effect of the compact boundary layer, and the geometry was adjusted to 120×25×10 mm³. Tensile measurements on the components were conducted in accordance with ISO 1926:2009 on a Zwick Z050 universal tester (Zwick & Roell, Ulm, Germany) with a sample geometry of 140 (30+80+30)×80×15 mm³ and a 20 kN load cell. Puncture characterization was effected with a Fractovis Plus drop bolt tester from Instron Ceast (Pianezza, Italy) with a maximum energy of 40 J and a puncture speed of 4.4 m/s (in accordance with DIN EN ISO 6603-2:2002-04) with a sample geometry of 60×60×15 mm³. All mechanical characterizations were performed at room temperature, 80° C. and 110° C., in each case with a 10 min intermediate step for temperature adjustment prior to the measurement. All components were analyzed at the same density around 200 kg/m³. Thermal conductivity measurements were conducted on an HFM 446 Lambda instrument from NETZSCH (Selb, Germany) at −10° C., 10° C., 25° C., 50° C. and 70° C.

The OH number of the polymers was ascertained by 1H NMR spectroscopy with dichloromethane as solvent at room temperature by evaluating the ratio of the integrals of the signals at 6.68 ppm (2 aromatic protons in ortho positions to phenolic OH groups) and at 1.68 ppm (6 methyl protons of the bisphenol A unit).

TABLE 1
Detailed compositions and analytical results of the study of the molar ratio according to example i)

| | E*-1 | E*-2 | E*- 3 | V-4 | V-5 | V-6 |
|---|---|---|---|---|---|---|
| PC1 [% by wt.] | 99.3 | 89.3 | 79.3 | 69.3 | 59.3 | 49.3 |
| PC2 [% by wt.] | 0 | 10 | 20 | 30 | 40 | 50 |
| PC1 throughput [g/h] | 34760 | 31280 | 27810 | 24330 | 20806 | 17380 |
| Pressure at end of A extruder [bar] | 270 | 275 | 250 | 288 | 189 | 176 |
| Pressure directly in front of die plate | 190 | 184 | 177 | 170 | 134 | 122 |
| [bar] | | | | | | |
| OH group content, based on total | 470 | 429 | 387 | 346 | 305 | 264 |
| weight of aromatic polycarbonate | | | | | | |
| [ppm] | | | | | | |
| Molar ratio of reactive OH group | 0.82 | 0.90 | 1.00 | 1.12 | 1.27 | 1.47 |
| (PC) to reactive group of the chain | | | | | | |
| extender (1:x) | | | | | | |
| M_{w} from GPC [g/mol] | 50180 | 52870 | 95690 | 93175 | 71691 | 50210 |
| M_{w} from GPC MALLS [kDa] | 158 | 168 | 206 | 207 | 139 | 107 |
| Particle density [kg/m³] | 197 | 234 | 265 | 27 | 260 | 253 |
| Average cell diameter [μm] | 100 ± 47 | 129 ± 77 | 139 ± 66 | 193 ± 99 | 193 ± 117 | 206 ± 134 |
| Cell density [cells/cm³] | 8.88 · 10⁵ | 4.12 · 10⁵ | 3.48 · 10⁵ | 1.47 · 10⁵ | 1.33 · 10⁵ | 1.18 · 10⁵ |
| Cell coalescence | no | no | no | yes | yes | yes |

TABLE 2
Detailed indices from the pressure tests, bending
tests and puncture tests for the comparative study
in example i) of the EPC particle foam components

| | EPC (E*-1) | EPC (V-4) |
|---|---|---|
| Component density [kg/m³] | 200 ± 10 | 230 ± 15 |
| Compression modulus [MPa] | 54.7 ± 5 | 50.9 ± 5.2 |
| Compressive strength at 10% | 1.61 ± 0.12 | 1.90 ± 0.14 |
| compression [MPa] | | |
| Flexural modulus [MPa] | 59.1 ± 11.4 | 86 ± 6.4 |
| Flexural strength [MPa] | 2.2 ± 0.3 | 2.52 ± 0.30 |
| Maximum flexural strain [%] | 8.8 ± 1.1 | 5.1 ± 0.7 |
| Maximum force [N] | 1688 ± 27 | 936 ± 107 |
| Puncture force [N] | 844 ± 29 | 467 ± 53 |
| Total energy [J] | 21.2 ± 3 | 12.2 ± 2 |
| Total deformation [mm] | 33.9 | 28.4 ± 7 |

Note:
Component made from EPC (V-4) has a foam density of 230 kg/m³. The indices here are original and would have to be calculated with a factor of 0.85 for simple percentage standardization.

These tests established that the starting material that should be used for further tests is aromatic polycarbonate which, based on the total weight of the aromatic polycarbonate, has a content of OH end groups of at least 350 ppm, determined by 1H NMR spectroscopy with dichloromethane as solvent at room temperature, and that a sufficient amount of chain extender should be used that 0.64-1.10 mol of the reactive group of the chain extender is used per 1 mol of OH end groups of the polycarbonate.

### Inventive Example 1

System setup: A twin-screw extruder of the ZSK 26 MC type (from Coperion GmbH) with 44 D and a gas metering station (from Promix Solutions GmbH), a heat exchanger, followed by a melt pump (from Maag-Germany GmbH) and an underwater pelletizer of the LPU type (from Maag-Germany GmbH) with die plate geometry: 2 holes with hole diameter 2.4 mm and die land 12.7 mm and with a blade speed of 4500 rpm (7-blade knife).

Formulation: 99.3% by weight of aromatic polycarbonate PC-1, 0.7% by weight of polyfunctional chain extender CE-1, 1.3% by weight of CO₂. Molar ratio of the reactive groups, OH groups of the polycarbonate:epoxy, is 1 mol: 0.82 mol.

Process: The throughput was 20 kg/h at a set temperature in the extruder and in the heat exchanger of 285° C. The extruder speed was 230 rpm. The melt pressure in the extruder was 64 bar. The melting temperature upstream of the diverter was 290° C. The temperature of the die plate was 330° C. at a melt pressure of 177 bar. The process water temperature was 92° C. at a water pressure of 2.5 bar. The dwell time in the system was 400 s.

Result: Particles having an average diameter of 2.4-2.6 mm, a particle density according to the buoyancy principle of 505 kg/m³, an average cell diameter of 82 μm, an open-cell content of 6%, a phase angle in the Van Gurp-Palmen plot of 72° and a quotient Q of 4.65·10⁻⁴ (°·mol/g) were obtained. The particles were weldable at 4 bar in a “standard” steam diffusion welding process and led, at a post-expansion of 47% by volume (100%−(100*density after welding/density before welding), to a molded article with a component density of 270 kg/m³. The molded article has a compact continuous surface (table 3), could not be broken manually and showed a flexural strain at force maximum of 6.4% in the bending test.

### Inventive Example 2

### Changes Compared to Inventive Example 1

System setup: An additional melt pump (Maag-Germany GmbH) upstream of the heat exchanger. The die plate geometry was 3 holes with hole diameter 1.8 mm and die land 11 mm, and the blade speed was 4700 rpm.

Process: The temperature of the die plate was 330° C. at a melt pressure of 162 bar. The process water temperature was 91° C. at a water pressure of 2 bar. The dwell time in the system was 420 s.

Result: Particles having an average diameter of 2.0-2.2 mm, a particle density of 614 kg/m³, an average cell diameter of 54 μm, an open-cell content of 4%, a phase angle in the Van Gurp-Palmen plot of 72° and a quotient Q of 8.0· 10-4 (°·mol/g) were obtained. The particles were weldable at 4 bar in a “standard” steam diffusion welding process and led, at a post-expansion of 46% by volume, to a molded article with a component density of 330 kg/m³. The molded article had a compact continuous surface (table 3), could not be broken manually and showed a flexural strain at force maximum of 5.8% in the bending test.

### Inventive Example 3

### Changes Compared to Inventive Example 1

System setup: An additional melt pump (Maag-Germany GmbH) upstream of the heat exchanger. The blade speed was 4700 rpm.

Process: The extruder speed was 150 rpm. The melting temperature upstream of the diverter was 285° C. The temperature of the die plate was 335° C. at a melt pressure of 189 bar. The process water temperature was 85° C. at a water pressure of 1.5 bar. The dwell time in the system was 460 s.

Result: Particles having an average diameter of 2.4-2.6 mm, a particle density of 485 kg/m³, an average cell diameter of 43 μm, an open-cell content of 4%, a phase angle of 71° and a quotient Q of 9.47·10⁻⁴ (°·mol/g) were obtained. The particles were weldable at 4 bar in a “standard” steam diffusion welding process and led, at a post-expansion of 36% by volume, to a molded article with a component density of 310 kg/m³. The molded article had a compact continuous surface (table 3), could not be broken manually and showed a flexural strain at force maximum of 6.6% in the bending test (in accordance with ISO 1209-2:2007).

### Inventive Example 4

### Changes Compared to Inventive Example 1

System setup: An additional melt pump (Maag-Germany GmbH) upstream of the heat exchanger. The blade speed was 4700 rpm.

Process: The throughput was 24 kg/h. The melting temperature upstream of the diverter was 284° C. The temperature of the die plate was 335° C. at a melt pressure of 177 bar. The process water temperature was 85° C. at a water pressure of 1.8 bar. The dwell time in the system was 350 s.

Result: Particles having an average diameter of 2.6-3.2 mm, a particle density of 425 kg/m³, an average cell diameter of 43 μm, an open-cell content of 15%, a phase angle of 74° and a quotient Q of 1.52·10⁻³ (°·mol/g) were obtained. The particles were weldable at 4 bar in a “standard” steam diffusion welding process and, with a post-expansion of 31% by volume, resulted in a molded article with a component density of 290 kg/m³. The molded article had a compact continuous surface (table 3), could not be broken manually and showed a flexural strain at force maximum of 6.0% in the bending test.

### Comparative Example 1

### Changes Compared to Inventive Example 1

System setup: No heat exchanger in the process.

Process: The temperature of the die plate was 330° C. at a melt pressure of 137 bar. The process water temperature was 85° C. at a water pressure of 3.5 bar. The dwell time in the system was very short at 90 s. Result: Particles having an average diameter of 2.6-2.8 mm, a particle density of 490 kg/m³, an average cell diameter of 41 μm, an open-cell content of 45%, a phase angle of 79° and a quotient Q outside the scope of the claims of 1.95·10⁻³ (°·mol/g) were obtained.

The particles had poor weldability at 4 bar in a “standard” steam diffusion welding process in spite of a post-expansion of 34% by volume. The ratio of molecular weight and chain branching was outside the optimal range. Inadequate molar mass and inadequate chain branching mean low melt strength and hence inadequate stabilization of morphology, which leads to a high open-cell content and poor welding. Molded articles resulting from this example consisted to some degree of loosely coalesced particles with a component density of 320 kg/m³. They did not have a compact closed surface (table 3), could be broken manually and showed flexural strain at force maximum of 2.1% in the bending test.

### Comparative Example 2

### Changes Compared to Inventive Example 1

System setup: An additional melt pump (Maag-Germany GmbH) upstream of the heat exchanger. The die plate geometry was 2 holes with a hole diameter of 2.8 mm and a die land of 6 mm.

Formulation: 99.5% by weight of aromatic polycarbonate PC-1, 0.5% by weight of polyfunctional chain extender CE-1, 1.3% by weight of CO₂. Molar ratio of the reactive groups, OH groups of the polycarbonate:epoxy, is 1 mol: 0.59 mol.

Process: The throughput was 24 kg/h. The temperature of the die plate was 330° C. at a melt pressure of 130 bar. The process water temperature was 91° C. at a water pressure of 2 bar. The dwell time in the system was 430 s.

Result: Particles having an average diameter of 2.4-2.6 mm, a particle density of 370 kg/m³, an average cell diameter of 81 μm, an open-cell content of 40%, a phase angle of 84° and a quotient Q outside the scope of the claims of 2.71·10⁻³ (°·mol/g) were obtained.

The particles were not weldable at 4 bar in a “standard” steam diffusion welding process, showed no post-expansion and collapsed in the mold as a result of an inadequate molecular ratio of the reactive groups for a chemical molecular weight-increasing reaction at a dwell time of 430 s. The resulting molded articles consisted of loosely coalesced particles, did not have a compact continuous surface (table 3) and broke under their own weight (lowest possible load). For the bending test, a flexural strain at force maximum of 0% was reported for this material.

Below is an overview (table 3) of the experimental results obtained.

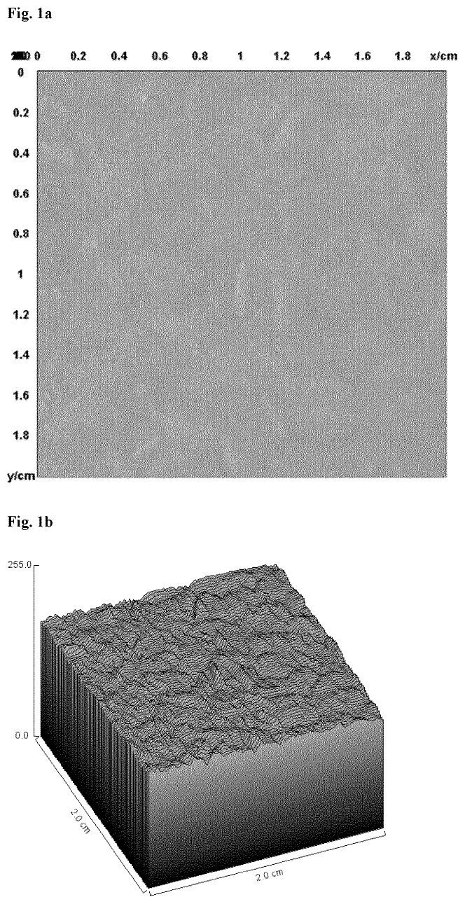

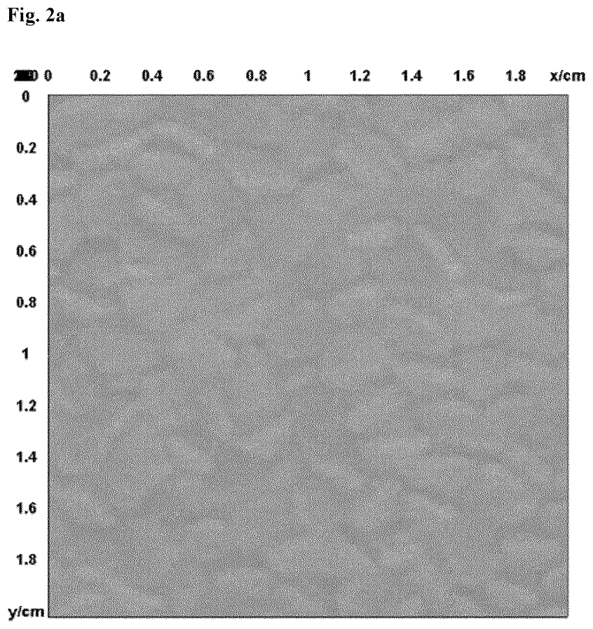

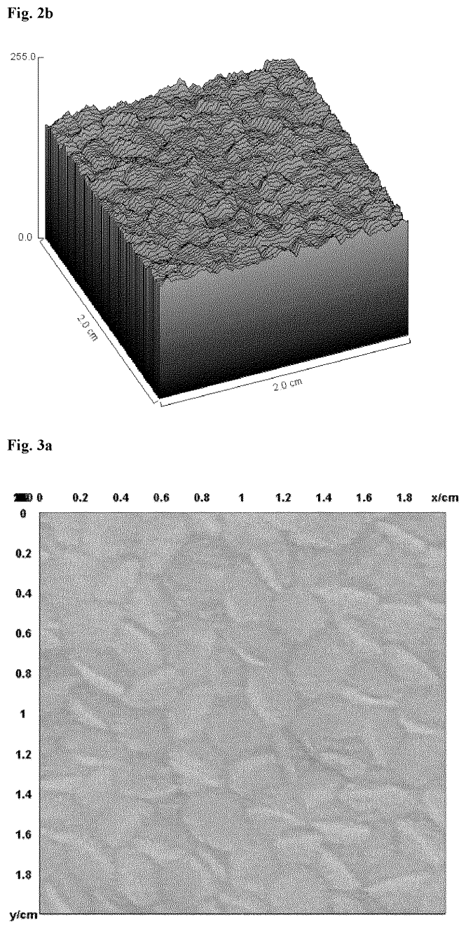

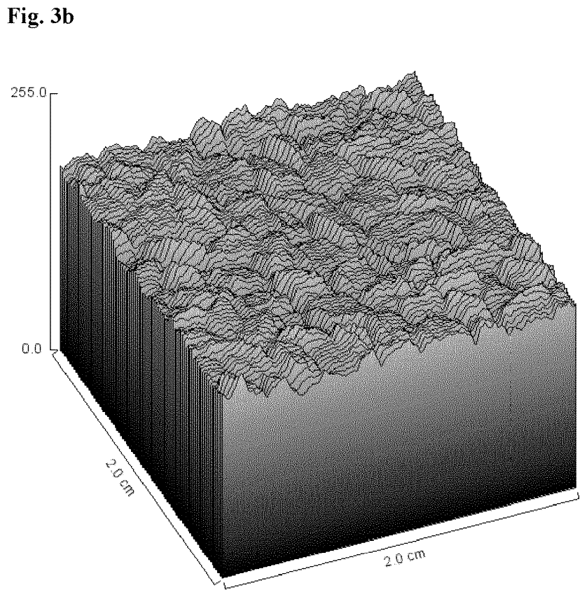

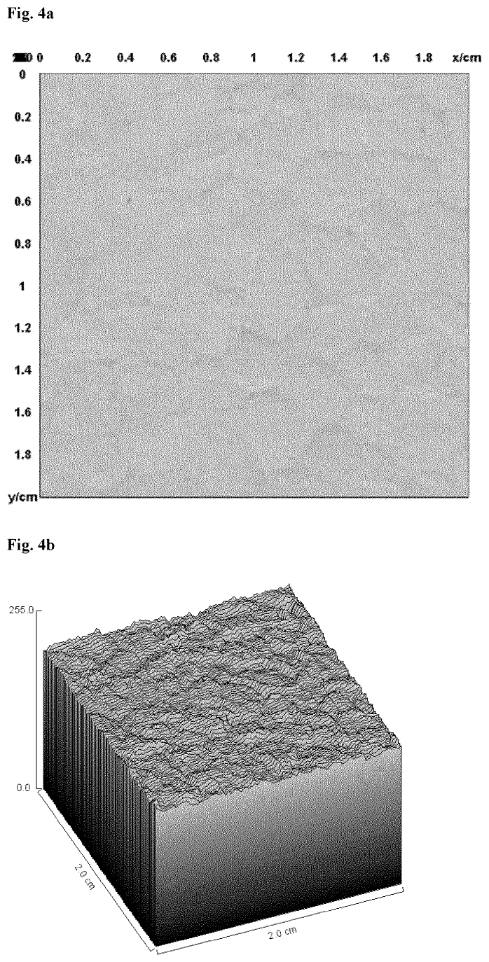

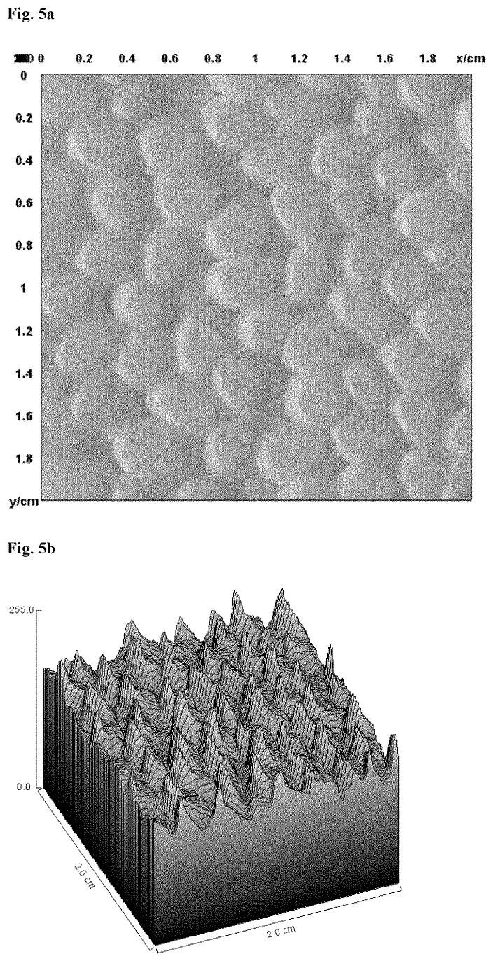

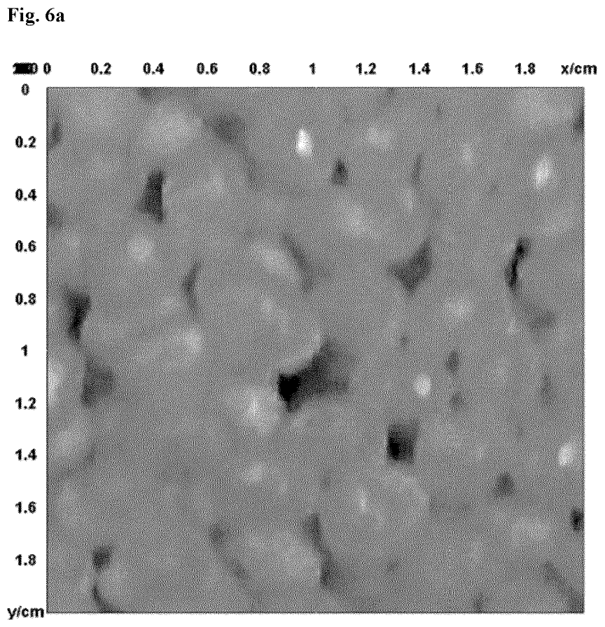

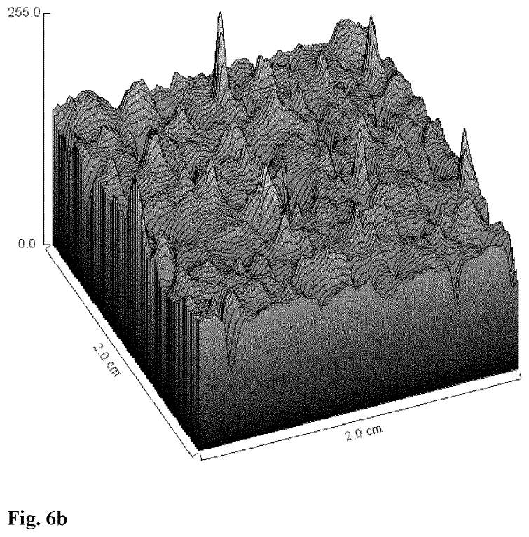

TABLE 3
Overview of the molded article quality and the bead properties of the inventive examples and the comparative examples

| | Properties of the beads | | | | | | | Shaped article properties | | | |
|---|---|---|---|---|---|---|---|---|---|---|---|
| | Average | | Open- | | | | | Weldability | | | Flexural |
| | particle | Particle | cell | | | Quotient | Post-ex- | in the | | Component | strain at |
| | diameter | density | content | M_{w} | δ | Q = δ/M_{w} | pansion | standard | | density | force max. |
| | [mm] | [kg/m³] | [%] | [g/mol] | [°] | [° · mol/g] | [%] | process | Surface | [kg/m³] | [%] |
| Inventive | 2.4-2.6 | 505 | 6 | 155,000 | 72 | 4.65 · 10⁻⁴ | 47 | yes | continuous, | 270 | 6.4 |
| example 1 | | | | | | | | | FIG. 1a, 1b | | |
| Inventive | 2.0-2.2 | 614 | 4 | 90,000 | 72 | 8.0 · 10⁻⁴ | 46 | yes | continuous, | 330 | 5.8 |
| example 2 | | | | | | | | | FIG. 2a, 2b | | |
| Inventive | 2.4-2.6 | 485 | 4 | 75,000 | 71 | 9.47 · 10⁻⁴ | 36 | yes | continuous, | 310 | 6.6 |
| example 3 | | | | | | | | | FIG. 3a, 3b | | |
| Inventive | 2.6-3.2 | 425 | 15 | 50,000 | 74 | 1.52 · 10⁻³ | 31 | yes | continuous, | 290 | 6.0 |
| example 4 | | | | | | | | | FIG. 4a, 4b | | |
| Comparative | 2.6-2.8 | 490 | 45 | 40,500 | 79 | 1.93 · 10⁻³ | 34 | no | not | 320 | 2.1 |
| example 1 | | | | | | | | | continuous, | | |
| | | | | | | | | | FIG. 5a, 5b | | |
| Comparative | 2.4-2.6 | 370 | 40 | 31,000 | 84 | 2.71 · 10⁻³ | none | no | not | 370 | 0 |
| example 2 | | | | | | | | | continuous | | |
| | | | | | | | | | FIG. 6a, 6b | | |

1. A process for producing post-expandable foamed polycarbonate beads by means of
a) continuous particle foam extrusion of a plastified mixture in an extrusion process,
where the mixture contains the following components:
i) aromatic polycarbonate, where the aromatic polycarbonate, based on the total weight of the aromatic polycarbonate, has a content of OH end groups of at least 350 ppm, determined by 1H NMR spectroscopy with dichloromethane as solvent at room temperature,
and
ii) a chain extender suitable for OH groups,
wherein the aromatic polycarbonate and the chain extender suitable for OH groups are used in such a molar ratio that 0.64-1.10 mol of the reactive group of the chain extender is used per 1 mol of OH end groups of the polycarbonate,
and
iii) a physical blowing agent,
at a temperature T of the plastified mixture of T₁=(T_{g}+110° C.) to T₂=(T_{g}+170° C.),
where T_{g} is the glass transition temperature of the aromatic polycarbonate,
wherein the dwell time of the aromatic polycarbonate and of the chain extender suitable for OH groups in the molten state is at least 4 minutes, and
b) subsequent underwater pelletization of the blowing agent-containing melt at water temperatures T₃=(T_{g}−90° C.) to T₄=(T_{g}−55° C.), where T_{g} is the glass transition temperature of the aromatic polycarbonate,
without pressurization or under pressurization of the water up to 3.5 bar.

2. The process as claimed in claim 1, wherein the dwell time of the mixture in the molten state is at least 5.5 min.

3. The process as claimed in claim 1, wherein 0.8-1.0 mol of the reactive group of the chain extender is used per 1 mol of OH end groups of the polycarbonate.

4. The process as claimed in claim 1, wherein the underwater pelletization of the blowing agent-containing melt is effected under pressurization of the water at 1.5 to 2.5 bar.

5. The process as claimed in claim 1, wherein the average particle diameters of the post-expandable foamed polycarbonate beads are adjusted to 1.0 to 3.2 mm.

6. The process as claimed in claim 1, wherein the beads obtained by step b) are stored prior to further processing until a complete gas exchange has taken place.

7. Blowing agent-free, foamed polycarbonate beads
having a weight-average molecular weight M_{w} of the polycarbonate, determined by GPC measurement in dichloromethane, calibrated against bisphenol A polycarbonate standards, of 50 000 to 160 000 g/mol, wherein
the foamed polycarbonate beads are post-expandable and show post-expansion of 20% to 60% by volume on welding at 4 bar in water vapor without pretreatment of the beads and
where the foamed polycarbonate beads are subject to the following condition:
$$Q = \frac{δ}{{M}_{w}} = 3.2 \cdot {10}^{- 4} to 1.93 \cdot {10}^{- 3} ( ° \cdot \frac{mol}{g} )$$
with δ=the phase angle in the Van Gurp-Palmen plot, determined at a complex shear modulus |G*|=3000 Pa and a temperature of 240° C., where δ<78.0°,
and
M_{w} as described above.

8. Blowing agent-free, foamed polycarbonate beads as claimed in claim 7, wherein the polycarbonate beads are spherical or approximately spherical, “approximately spherical” meaning that, if the sphere is described by axes of equal length directed into space from a common origin, the axes defining the radius of the sphere in all spatial directions, there is a variance of the axis lengths from the ideal state of a sphere of up to 20% for the spherical particles.

9. Blowing agent-free, foamed polycarbonate beads as claimed in claim 7, wherein the phase angle δ in the Van Gurp-Palmen plot, determined at a complex shear modulus |G*|=3000 Pa and a temperature of 240° C., is 64° to <78.0°.

10. Foamed polycarbonate beads as claimed in claim 7, wherein the phase angle δ in the Van Gurp-Palmen plot, determined at a complex shear modulus |G*|=3000 Pa and a temperature of 240° C., is <75°.

11. Foamed polycarbonate beads as claimed in claim 7, wherein the foamed polycarbonate beads have an open-cell content of up to 20%, determined in accordance with DIN EN ISO 4590:2016-12.

12. Foamed polycarbonate beads as claimed in claim 7, wherein the polycarbonate beads have an open-cell content of up to 15%, determined in accordance with DIN EN ISO 4590:2016-12.

13. Foamed polycarbonate beads as claimed in claim 7, wherein the polycarbonate beads show post-expansion of 30 to 50% on welding at 4 bar in water vapor without pretreatment of the beads.

14. A molded article produced from the blowing agent-free foamed polycarbonate beads as claimed in claim 7.

15. A process for producing molded articles as claimed in claim 14, wherein the molded articles are produced by means of steam at average absolute steam pressures of 4 to 6 bar.

16. The process as claimed in claim 1, wherein the average particle diameters of the post-expandable foamed polycarbonate beads are adjusted to 2 to 2.6 mm.
